(19) United States
(12) Patent Application Publication
(10) Pub. No.: US 2003/0058604 A1
(43) Pub. Date: Mar. 27, 2003

(54) Method and apparatus to emulate external IO interconnection

(76) Inventors: Karthisha S. Canagasaby, Santa Clara, CA (US); Sanjay Dabral, Palo Alto, CA (US)

Correspondence Address: Tom Van Zandt, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/982,242

(22) Filed: Oct. 16, 2001

Related U.S. Application Data
(63) Continuation-in-part of application No. 09/951,750, filed on Sep. 13, 2001.

(51) Int. Cl. H01G 4/35

(52) U.S. Cl. 361/302

(57) ABSTRACT

A method and apparatus are described herein that may be used to provide the cost effective characterization of IO interconnections as simplified RC networks thus allowing for efficient testing of multiple different external interconnection topologies. In one embodiment the electrical characteristics of an IO interconnection are measured and characterized. A resistive-captive network is then designed so that it approximates the IO interconnection within some specified tolerance. The RC network may be fabricated on-chip between the driver and the receiver of an IO port or the RC network may be implemented on a PCB to facilitate production testing. In an alternative embodiment, closer approximation to the actual characteristics of the IO interconnection is achieved through the conjunction of several RC networks. Moreover, this process is repeatable for the emulation of multiple different links.

### CROSS-REFERENCE TO RELATED APPLICATION

This application is a Continuation-in-Part of U.S. patent application Ser. No. 09/951,750. filed Sep. 13, 2001, entitled “METHOD AND APPARATUS TO EMULATE IO INTERCONNECTION”

### FIELD OF THE INVENTION

This invention relates generally to the input/output (IO) interfaces of integrated circuits (ICs), and more specifically to methods and apparatuses for emulating the external interconnections of such interfaces when analyzing the IO interface circuitry.

### BACKGROUND OF THE INVENTION

ICs today are so densely packed and have achieved such high speeds that a significant portion of the total delay in a processing unit could be due to the time required for signals to travel externally from one chip to another. Hence, interconnections have become a major concern in high-performance integrated circuits because the resistance and capacitance of interconnections increases rapidly as more and more components such as PCB, connectors, packages, etc., get added to the link. Moreover, it is costly and time consuming to test such external IO interconnect especially when the complexity is large. The cost and time multiplies when the requirement is to test the circuitry and the interconnect for multiple different system configurations.

An IC chip may contain several IO interfaces. Typically the IO interface contains at least a driver/receiver pair (IO port). The driver of one interface is connected to the receiver of another and vice versa. The two IO interfaces may be on different chips or even on different printed circuit boards (PCBs). As data is driven out over the interconnect path there is signal attenuation/degradation due to the components of the interconnection. Particularly for long interconnections, the losses of the lines are a major concern and may limit signal integrity. The interconnections between the IO interfaces typically might include the connectors, chip package, PCBs, etc., which contribute to these losses. The losses, in turn can be modeled as RC elements.

FIG. 1A shows the interconnection between a driver/receiver pair of two IO interfaces residing on different PCBs. As shown in FIG. 1A, this interconnection may be extensive. For example, the system 100A, of FIG. 1A shows a driver/receiver pair of chip 105A connected to a driver/receiver pair of chip 135A. The interconnection runs across chip package 110A and continues across PCB 115A. The interconnection may include one or more intermediate PCBs 120A and the accompanying board-to-board connections. The interconnection also includes the PCB 125A and the chip package 130A of the connected driver/receiver pair of chip 135A. Such interconnections with cumulative lengths of 20-30 inches are not uncommon.

The effect of such an interconnection upon the reliability of data transmission from an IO port of one chip to an IO port of another chip may be determined by constructing and analyzing a test system. However, such construction is costly, time consuming, and complex.

A typical way to determine, approximately, if an IO circuit interface will transmit valid data across an interconnection is to couple the driver of an IO interface to the receiver of the same IO interface as shown in FIG. 1B. The system 100B, of FIG. 1B shows a prior art loop-back method of testing an on-chip IO circuit interface. FIG. 1B shows chip 105B residing on PCB 110B. An IO interface on chip 105B has driver 101B coupled to receiver 102B by traces 103B. Data is driven from driver 101B across traces 103B to receiver 102B. The data is then evaluated to determine if it is valid. To test the interface, the voltage swing driven out of the driver may be reduced to imitate the signal attenuation through an interconnection. The process is continued iteratively to determine the point at which the interface fails (i.e., at what point the data received at receiver 102B is no longer valid). This generalized approach tests the basic functionality of the analog circuit blocks of the IO interface as well as more stressed “lone-pulse” kind of conditions.

### BRIEF DESCRIPTION OF THE DRAWINGS

The present invention is illustrated by way of example, and not limitation, by the figures of the accompanying drawings in which like references indicate similar elements and in which:

FIG. 1A shows the interconnection between a driver/receiver pair of two IO interfaces residing on different printed circuit boards;

FIG. 1B shows a prior art loop-back method of testing an on-chip IO circuit interface;

FIG. 2 illustrates a process according to one embodiment of the present invention;

FIG. 3A compares “eye” diagrams for an interconnection and a test resistive/capacitive (RC) network as measured at the driver;

FIG. 3B compares “eye” diagrams for an interconnection and a test RC network as measured at the receiver; and

FIG. 4 shows a loop-back configuration in accordance with the present invention.

### DETAILED DESCRIPTION

The method and apparatus described herein may be used to provide the cost effective characterization of IO interconnections as simplified RC networks thus allowing for efficient testing of multiple different interconnection topologies. In one embodiment the electrical characteristics of an IO interconnection are measured and characterized. A programmable resistive-capacitive network is then used to approximate the external off-chip IO interconnection. The RC network is fabricated on-chip between the driver and the receiver of an IO port. In an alternative embodiment, closer approximation to the actual characteristics of the IO interconnection is achieved through the conjunction of several RC networks. In another aspect the RC network can be on-board as well.

This invention uses interconnect simulation programs to model IO interconnection circuitry. Crucial to this modeling is the understanding that a lossy IO interconnection may be accurately modeled as an RC network (i.e., for modeling purposes, a lossy interconnection may be replaced with an RC network). On-chip interconnections, packaging wires, and PCB wires of sufficient length have significant resistance and may be viewed as lossy transmission lines. As line resistance becomes greater than characteristic impedance, the inductive effects become negligible and the resistance dominates the electrical behavior.

The response to a unit step input to a model lossy transmission line having per unit length inductance, capacitance, and resistance is given by Equation 1. As shown by Equation 1, the response of such a line to a unit step input has two components. The first component of the response is a step function that is attenuated exponentially with distance from the beginning of the line. The second component of the response is dominated by the RC components of the line as the length of the line increases. This means that the delays and rise times are determined more by the RC components than by the time-of-flight delays for longer lines and for on-chip interconnections at higher frequencies. Equation 1 shows that the greater the resistance in comparison to the characteristic impedance, the more accurately the line may be modeled by an RC network. Therefore, using an RC network to emulate an IO interface interconnection is most appropriate and beneficial for high-speed circuits with lengthy interconnections.

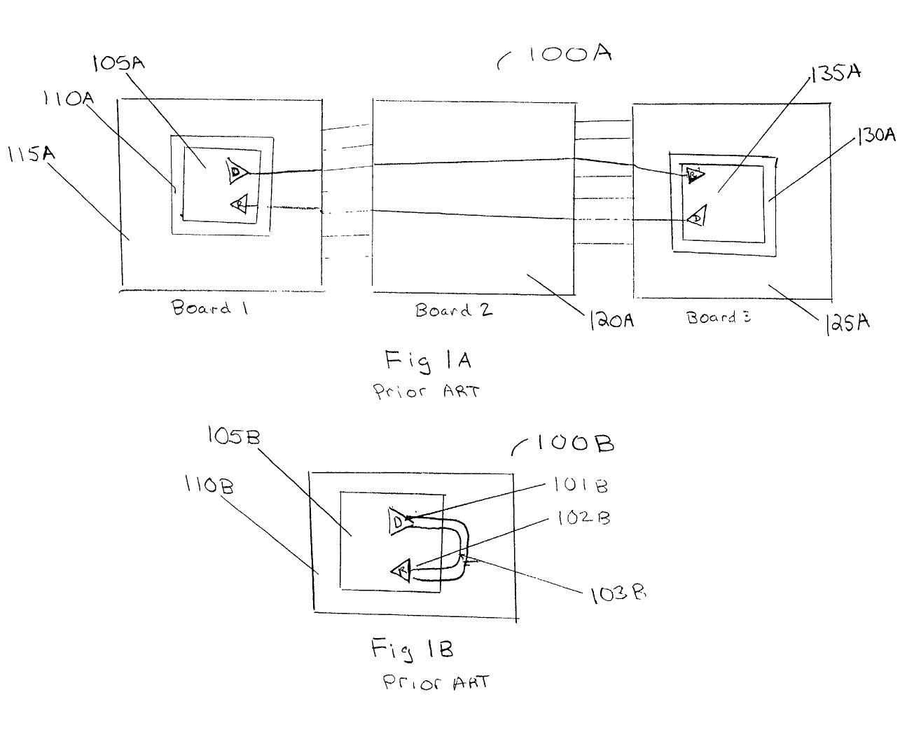

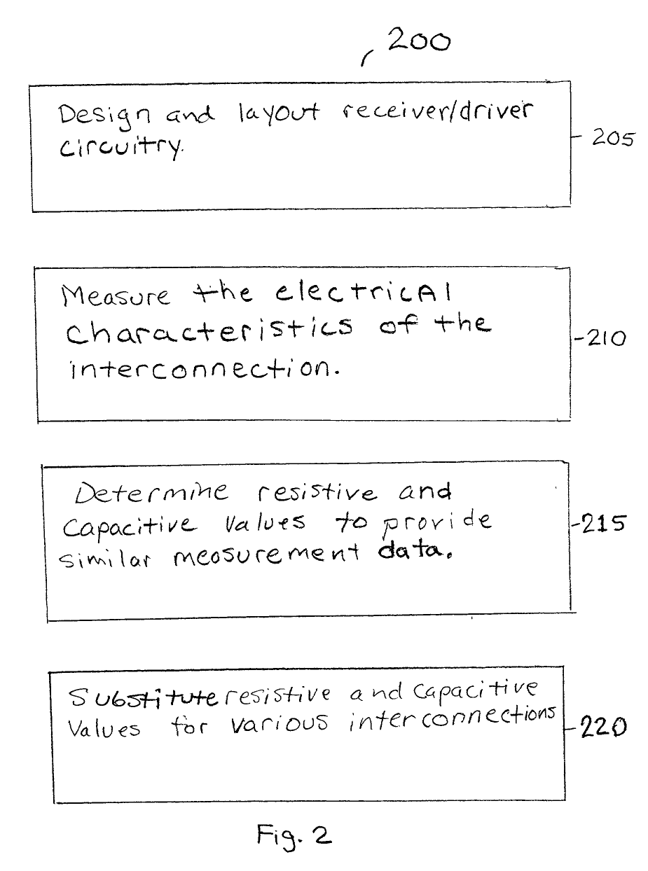

FIG. 2 illustrates a process according to one embodiment of the present invention. The process 200, shown in FIG. 2, begins at operation 205 in which the circuitry for the IO interconnection is designed and laid out. As described above, and shown in FIG. 1A, interconnections between the IO interfaces include the connectors, chip package, and PCBs including intermediate PCBs.

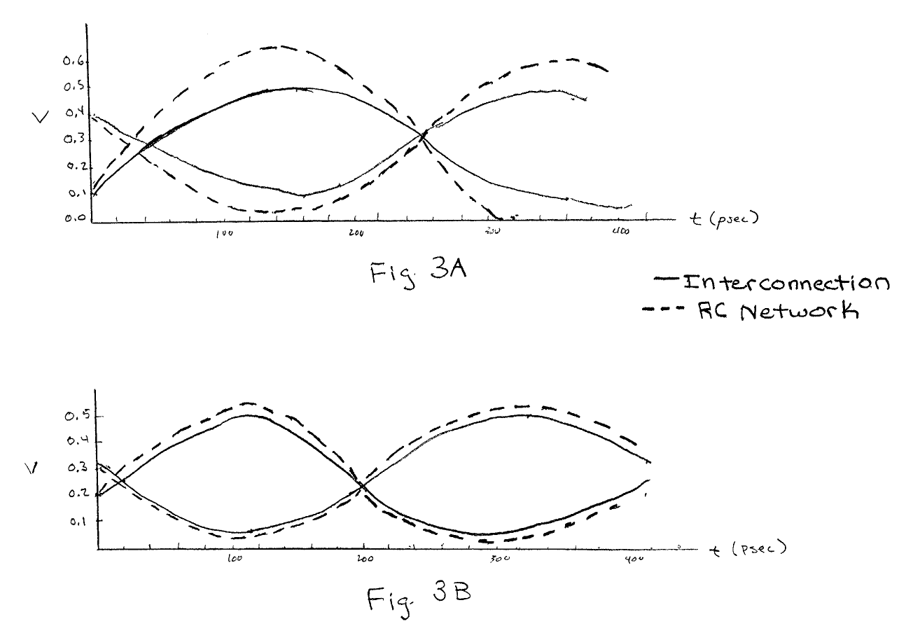

At operation 210 the quality of IO interconnection is measured and its characteristics noted. For example, an interconnection may be evaluated in terms of its measured voltage over time using an oscilloscope. In one embodiment the actual interconnection may be measured, in an alternative embodiment the actual interconnection may be simulated using simulation software. Characteristics for components of the interconnection may also be obtained from the vendors' specifications for the components. Representations of typical resulting “eye” diagrams from such measurements are shown in FIGS. 3A (driver side) and 3B (receiver side) with solid line. In alternative embodiments, other measurements may be made that characterize the interconnection.

At operation 215, circuit simulation software is used to determine resistive and capacitive values that approximate the interconnection circuit. That is, a simple RC network is measured and the resistance values and capacitance values are adjusted until the electrical behavior of the circuit approximates that of the off-chip interconnection. For example, as shown in FIGS. 3A and 3B with dashed lines, “eye” diagrams may be produced for a test RC network at both the driver (3A) and the receiver (3B). As depicted in FIG. 3B, a simplified RC network approximation may emulate the more complex interconnection reasonably well. In one embodiment the RC network may approximate the interconnection within a 10% error tolerance. RC networks that emulate the characteristics of typical, or “worst case”, interconnections may be determined.

It is possible to obtain more precise approximations of the interconnection within the scope of the present invention by using more complex test RC networks. Alternative embodiments may employ multiple RC networks using poly resistance and distributed gate capacitance. A more precise model may be created by including additional parameters (e.g., the dielectric loss of the PCB traces). The same can be made adaptive by having programmable resistive and capacitive components so different topologies of the IO link could be emulated.

In operation 220 the resistive and capacitive values determined in operation 215 are used to create RC networks for desired interconnection topologies. Such RC networks are then implemented between the driver and receiver of the IO interface to emulate the interconnection and provide test data.

In one embodiment the test RC network may be fabricated on-chip between the driver and receiver of an IO interface. Because this eliminates the need to produce external test interconnection components such as PCB, connectors, packages, etc., the testing costs and time are reduced.

In an alternative embodiment the test RC network may be implemented on the chip package or PCB level. This allows for efficient production tests in which thousands of ICs may be evaluated. Also, enhancements may be made in the AC IO loopback mode by substituting an equivalent test RC network in the loopback path.

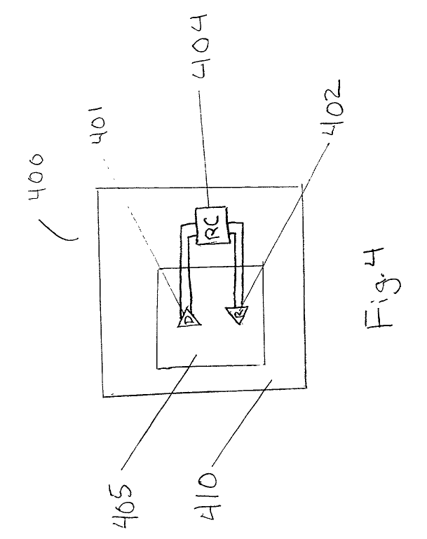

FIG. 4 shows a loop-back configuration in accordance with the present invention. The system 400, shown in FIG. 4 shows chip 405 residing on PCB 410. An IO interface on chip 405 has driver 401 coupled to receiver 402 through an RC network 404 that emulates the interconnection. The RC network 404 provides a much more accurate approximation of the signal attenuation through an interconnection than the prior art configuration of FIG. 1B.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
measuring electrical characteristics of an interconnection; and
determining a test network having electrical characteristics such that the electrical characteristics of the interconnection are approximated by the electrical characteristics of the test network within a specified tolerance.

2. The method of claim 1 wherein the test network is a resistive/capacitive network.

3. The method of claim 2 wherein measuring includes creating a graphical representation of an output of the interconnection.

4. The method of claim 3 wherein determining includes creating a graphical representation of an output of the resistive/capacitive network that approximates the graphical representation of the output of the interconnection within a specified tolerance.

5. The method of claim 4 wherein the specified tolerance is 10%.

6. The method of claim 1 wherein the test network is a resistive network.

7. The method of claim 1 wherein the test network is a capacitive network.

8. The method of claim 1 wherein the test network is comprised of a plurality of resistive/capacitive networks.

9. The method of claim 2 further including:
connecting the resistive/capacitive network between a driver of a first input/output circuit and a receiver of a second input/output circuit.

10. The method of claim 2 further including:
connecting the resistive/capacitive network between a driver of an input/output circuit and a receiver of the input/output circuit.

11. The method of claim 10 wherein the resistance and capacitance of the resistive/capacitive network are adjustable.

12. The method of claim 11 wherein the resistive/capacitive network is implemented on an integrated circuit chip.

13. The method of claim 12 wherein the capacitance is distributed RC ladder.

14. The method of claim 11 wherein the resistive/capacitive network is implemented on a printed circuit board.

15. An apparatus comprising:
an integrated circuit having at least one input/output ports, the at least one input/output ports having a driver and a receiver; and
a test network electrically coupling the driver and the receiver such that an input/output interface interconnection may be emulated therewith.

16. The apparatus of claim 15 wherein the test network is a resistive/capacitive network.

17. The apparatus of claim 15 wherein the test network is a resistive network.

18. The apparatus of claim 15 wherein the test network is a capacitive network.

19. The apparatus of claim 16 wherein the resistance and capacitance of the resistive/capacitive network are adjustable.

20. The apparatus of claim 16 wherein the integrated circuit and the resistive/capacitive network are implemented on a same integrated circuit chip.

21. The apparatus of claim 16 wherein the resistive/capacitive network is implemented on a printed circuit board.

22. The apparatus of claim 15 wherein the integrated circuit is part of a microprocessor.

23. An apparatus comprising:
a test network for an input/output interface having elements selected such that electrical characteristics of the test network approximate electrical characteristics of an input/output interface interconnection within a specified tolerance.

24. The apparatus of claim 23 wherein the elements are resistive elements and capacitive elements.

25. The apparatus of claim 24 wherein the resistive elements and the capacitive elements are adjustable such that the test network may be used to approximate the electrical characteristics of a plurality of input/output interface interconnections.

26. The apparatus of claim 24 wherein the test network is comprised of a plurality of resistive/capacitive networks.

27. The apparatus of claim 26 wherein the capacitive elements are distributed RC ladder.

28. The apparatus of claim 27 implemented within an integrated circuit chip.

29. The apparatus of claim 27 implemented on a printed circuit board.

30. The apparatus of claim 23 wherein the elements are determined such that a graphical representation of an output of the test network approximates, within a specified tolerance, the graphical representation of an output of a particular input/output interface interconnection.
